(19) United States
(12) Patent Application Publication
(10) Pub. No.: US 2013/0166523 A1
(43) Pub. Date: Jun. 27, 2013

(54) Parallel Execution In A Transaction Using Independent Queries

(71) Applicants: Amit PATHAK, Magarpatta City (IN); Sunil Sayyaparaju, Andhra Pradesh (IN); Rahul Mittal, Indore (IN)

(72) Inventors: Amit PATHAK, Magarpatta City (IN); Sunil Sayyaparaju, Andhra Pradesh (IN); Rahul Mittal, Indore (IN)

(73) Assignee: Sybase, Inc., Dublin, CA (US)

(21) Appl. No.: 13/332,483

(22) Filed: Dec. 21, 2011

(51) Int. Cl. G06F 17/30

(52) U.S. Cl. 707/703; 707/E17.005

(57) ABSTRACT

Embodiments include a method, apparatus and computer program product for executing a database transaction in parallel using subtransactions. The method includes receiving a transaction at an application, the transaction having a first statement and a second statement, and determining whether operation of the first statement is independent from operation of the second statement. When it is determined that operation of the first statement is independent from operation of the second statement, assigning the first statement to a first subtransaction and the second statement to a second subtransaction, the first and second subtransactions being part of a transaction group. The method further includes executing the subtransactions using resources of the database. Finally, when execution of all of the subtransactions have successfully completed, committing all of the subtransactions.

### FIELD OF THE INVENTION

The present invention generally relates to improving database performance.

### BACKGROUND OF THE INVENTION

Computer applications increasingly rely on database systems. Modern database systems have implemented different techniques to improve system performance. Database performance can be improved by having database instructions executed in parallel by multiple database processing elements.

Though different techniques exist for parallel processing, these techniques generally involve distributing the execution of database instructions across different databases. While these techniques can improve performance, they generally require complex external coordination processes to be successful. In addition, these distributed techniques cannot be controlled using structured query language (SQL) statements.

### BRIEF SUMMARY

Embodiments of the present invention relate to the parallel processing of database instructions. Specifically, embodiments provide a method, apparatus and computer program product for executing a database transaction in parallel using subtransactions. The method includes receiving a transaction at a database, the transaction having a first statement and a second statement, and determining whether operation of the first statement is independent from operation of the second statement. When it is determined that operation of the first statement is independent from operation of the second statement, assigning the first statement to a first subtransaction and the second statement to a second subtransaction, the first and second subtransactions being part of a transaction group. The method further includes executing the subtransactions using resources of the database and, when execution of all of the subtransactions have successfully completed, committing all of the subtransactions.

Another embodiment includes a database configured to execute in parallel a database transaction using subtransactions. The database includes a transaction receiver configured to receive a database transaction having a first statement and a second statement, and an independence determiner configured to determine whether operation of the first statement is independent from operation of the second statement. A subtransaction creator is configured to, when it is determined that operation of the first statement is independent from operation of the second statement, assign the first statement to a first subtransaction and the second statement to a second subtransaction, the first and second subtransactions being part of a transaction group. A database engine is configured to execute the subtransactions in parallel, and, when execution of all of the subtransactions have successfully completed, commit all of the subtransactions.

Further features and advantages, as well as the structure and operation of various embodiments are described in detail below with reference to the accompanying drawings.

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 depicts a conventional database system having a transaction and a database engine.

FIG. 2A depicts a database system having a transaction group with two member subtransactions, according to an embodiment of the present invention.

FIG. 2B depicts a detailed view of a database system having a transaction group with two member subtransactions, according to an embodiment.

FIG. 3 depicts a database system having a transaction group with two member subtransactions and a commit/rollback engine, according to an embodiment.

FIG. 4A depicts a database system having a lock manager, according to an embodiment.

FIG. 4B depicts a member sub-transaction with two statements and a lock, according to an embodiment.

FIG. 5 depicts a member sub-transaction with two statements, two locks, and a statement, according to an embodiment.

FIG. 6 shows a flowchart illustrating a method of executing a database transaction in parallel using subtransactions, according to an embodiment of the present invention.

FIG. 7 illustrates an example computer system, useful for implementing components of embodiments described herein, according to an embodiment of the present invention.

The features and advantages of the present invention will become more apparent from the detailed description set forth below when taken in conjunction with the drawings.

### DETAILED DESCRIPTION OF EMBODIMENTS

The following detailed description of the present invention refers to the accompanying drawings that illustrate exemplary embodiments consistent with this invention. Other embodiments are possible, and modifications may be made to the embodiments within the spirit and scope of the invention. Therefore, the detailed description is not meant to limit the invention. Rather, the scope of the invention is defined by the appended claims.

Features and advantages of the invention are set forth in the description that follows, and in part are apparent from the description, or may be learned by practice of the invention. The advantages of the invention are realized and attained by the structure and operation and particularly pointed out in the written description and claims hereof as well as the appended drawings. The following detailed description is exemplary and explanatory and is intended to provide further explanation of the invention as claimed.

The embodiment(s) described and references in the specification to “one embodiment,” “an embodiment,” “an example embodiment,” etc., indicate that the embodiment(s) described may include a particular feature, structure, or characteristic. However, every embodiment may not necessarily include the particular feature, structure or characteristic. Moreover, such phrases are not necessarily referring to the same embodiment. When a particular feature, structure or characteristic is described in connection with an embodiment, it is understood that it is within the knowledge of one skilled in the art to effect such feature, structure, or characteristic in connection with other embodiments, whether or not explicitly described.

It would be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments is described with the understanding that modifications and variations of the embodiments are possible, given the level of detail presented herein.

### Overview of Embodiments

In some circumstances, result of execution of a statement in a transaction may not depend on the result of the earlier statements in the transaction. In such cases, the statement can be executed in parallel with the earlier statements without affecting the result of the transaction. A transaction having these types of statements can be spilt into multiple independent subtransactions such that each subtransaction can be executed in parallel without affecting the result of the transaction.

An embodiment breaks a conventional database transaction into multiple independently executing subtransactions. These subtransactions can be executed in parallel without affecting end result of the transaction. Other of embodiments allow processing portions of the transaction in parallel using multiple connections. In some embodiments, a SQL-language interface can be used to manage the transaction processing.

### Conventional Transactions

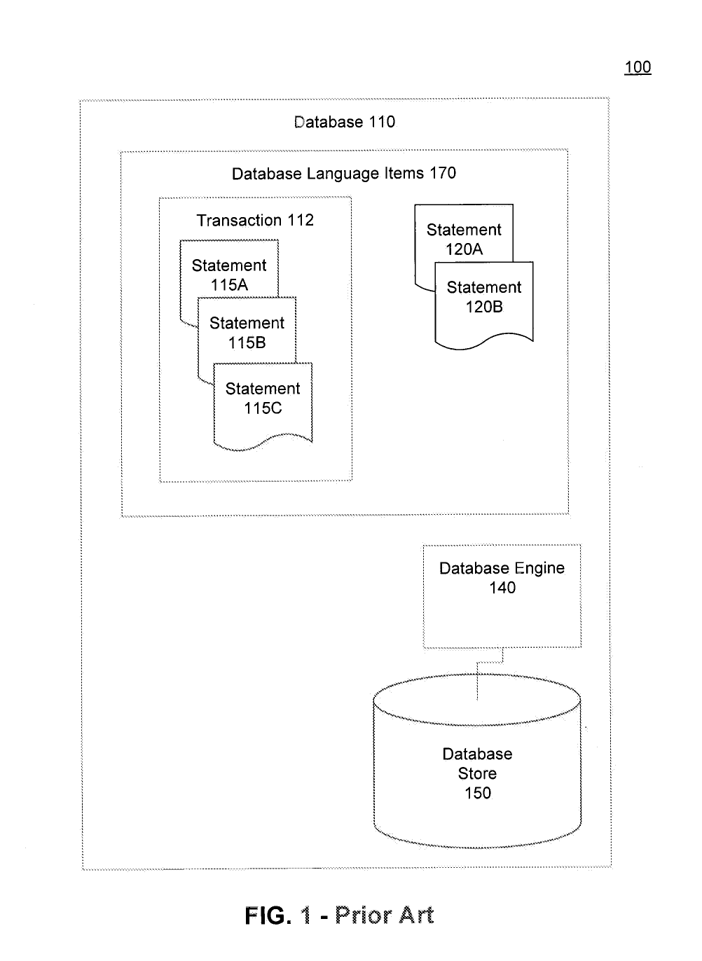

FIG. 1 is a block diagram of conventional database 110. Database 110 has database language items 170, and database store 150 coupled to database engine 140. Database language items 170 include statements 120A-B and transaction 112. Transaction 112 has statements 115A-C.

In conventional database system architecture 100 depicted on FIG. 1, database language items include statements 115A-C and 120A-B. Using a conventional approach to database transactions, statements 115A-C are part of transaction 112.

As would be appreciated by one having skill in the relevant art(s), database transactions provide an “all-or-nothing” proposition, with included work-units performed in a transaction either completing in their entirety or making no change to a database store. Thus, in FIG. 1, all of statements 115A-C must complete successfully or none of the statements 115A-C modifies the database store 150. Each statement 120A-B can succeed or fail without having an effect on any other statement.

Generally speaking, other than the “all-or-nothing” limitations described above, statements 115A-C are processed by database engine 140 according to standard processing approaches used to process all statements in database 110. No additional groupings or limitations are applied to transaction 112 statements 115A-C.

### Transaction Groups

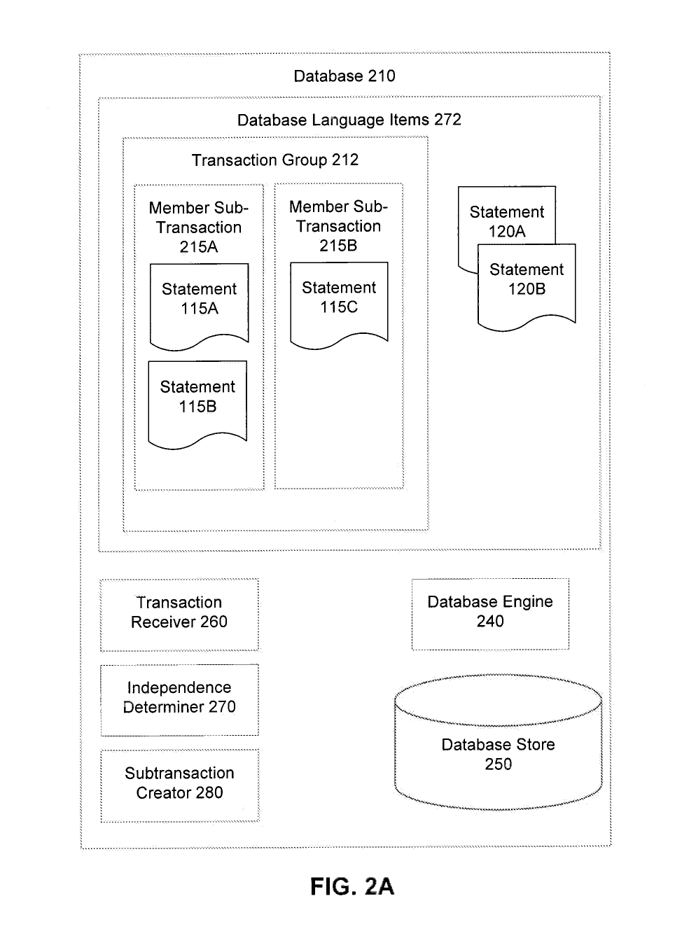

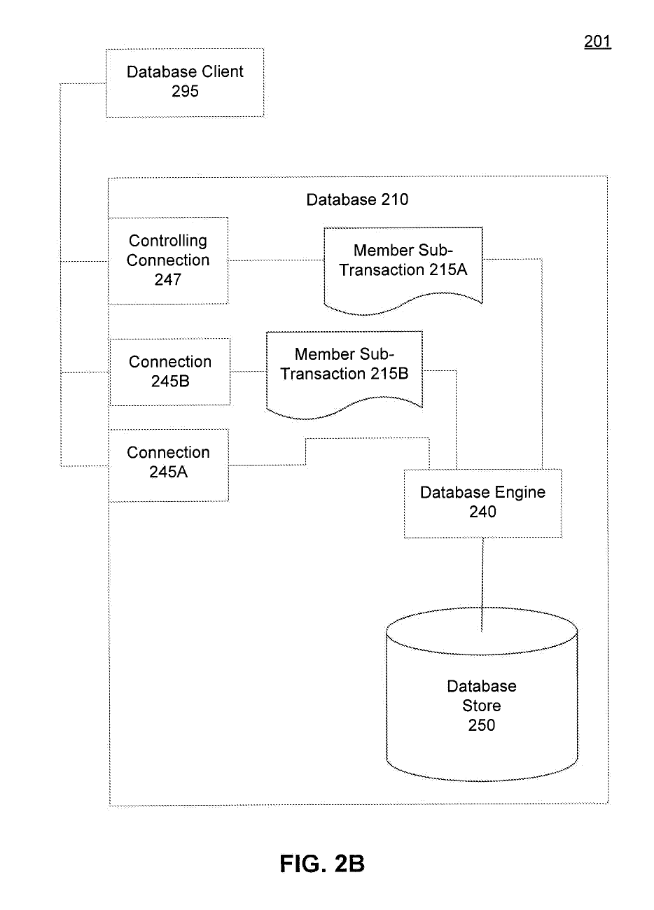

FIG. 2A is a block diagram of database 210, according to an embodiment. Database 210 has database language items 272, transaction receiver 260, independence determiner 270, subtransaction creator 280, database store 250 and database engine 240. Database language items 272 have statements 120A-B and transaction group 212. Transaction group 212 has member subtransactions 215A-B. Member subtransaction 215A has statements 115A-B and member subtransaction 215B has statement 115C.

In an embodiment, after being received by transaction receiver 260, instead of being conventionally executed as part of transaction 112, statements 115A-C are allocated by independence determiner 270 into member subtransactions 215A-B in transaction group 212. In the conversion, statements 115A-B are allocated to member subtransaction 215A, and statement 115C is allocated to member subtransaction 215B. Member subtransactions can also be termed “transaction branches” and “transaction members.” Transaction groups can also be termed “transaction families.”

### Subtransaction Creator

Different approaches can be used by embodiments to allocate transaction statements 115A-C to separate member subtransactions. One approach, used by independence determiner 270, analyzes statements 115A-C and determines which can be executed in parallel. Generally speaking, when two statements are independent then they can be executed in parallel. In an embodiment, a subtransaction creator starts with complete transaction as first subtransaction and determines if a statement in the transaction is independent of all the previous statements in the transaction. When a statement is determined to be independent, a separate subtransaction is created for it. One having skill in the relevant art(s), given the description herein, will appreciate the type of analysis used to identify statements that can and cannot be executed in parallel. For example, statements that operate on common data in database store 250 generally cannot be executed in parallel.

Following are examples E1-E2 of circumstances where statements are operating on common data and are not independent thus cannot be allocated into different member subtransactions for parallel operation. One having skill in the relevant art(s), given the description herein, would appreciate additional similar circumstances. Examples E1-E2 are listed below:

E1. Because of the different locks used in processing, different member transactions should not operate on a same database objects, e.g., tables.

E2. If a first table has referential integrity constraints (e.g., triggers) referencing a second table, these two tables should not be used in two different member subtransactions of a same group. Such a referential integrity constraint on the first table may require acquiring lock on the second table. This type of lock could lead to an access of common data.

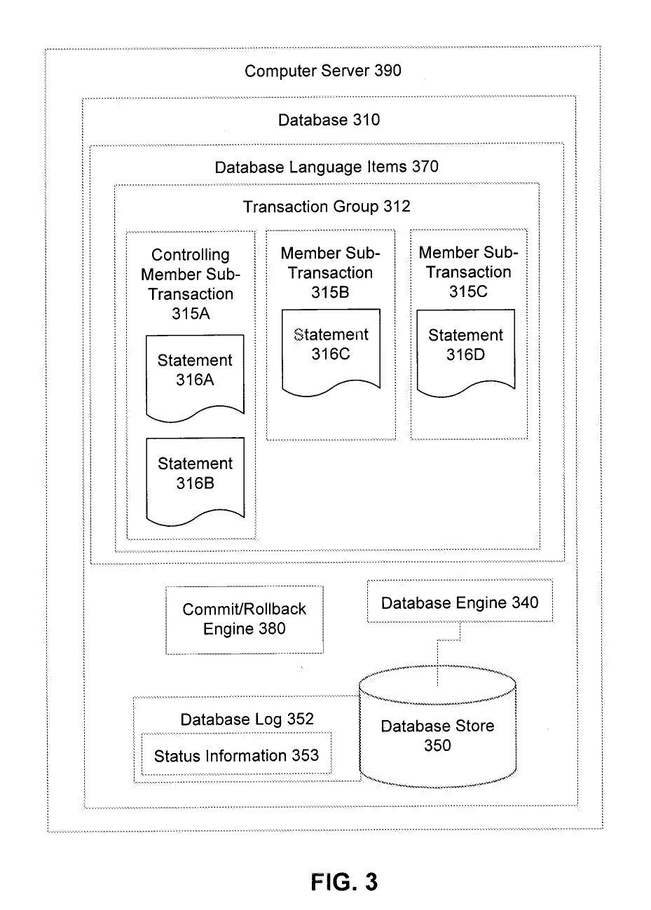

As discussed below with the description of FIG. 3, the above examples E1-E2 also describe circumstances that can trigger the abort and rollback of an entire transaction group, if occurring during the execution of any of the member subtransactions of the transaction group.

### Alternative Approaches to Creating Subtransactions

It is important to note that the subtransaction approaches described above can be implemented at different levels in the database architecture. For example, the functions performed by independence determiner 270 and subtransaction creator 280 can be implemented at a database client as well.

Another approach of allocating statements 115A-C to respective member subtransactions 215A-B used by an embodiment uses explicit commands from defining database statements. For example, when constructing transaction 112, a programmer can use domain logic to create member subtransaction and use coded instructions to allocate statements 115A-B to member subtransaction 215A and statement 115C to member subtransaction 215B. These coded instructions can be implemented in a variety of ways, including using a variation of SQL. In an another approach, at a database client connected to database 210, conventional transaction 112 is processed and split into independent member subtransactions 215A-B before the transaction is sent to transaction receiver 260 on database 210. In this approach client side libraries can be used to assist the functions of a client side independence determiner 270.

Using a database client with embodiments is discussed further with the description of FIG. 2B below.

### Single Connections and Multiple Connections

In an example, where a database server creates subtransactions from a submitted subtransaction, as shown in FIG. 2A, only one connection is used. A database client can submit an initial complete transaction on the same connection. In this example, once the database server receives the transaction, multiple subtransactions can be internally created by the database server. At the database server, each created subtransaction can be executed in parallel by spawning a separate thread/process for each subtransaction. In this example, the connection on which the initial complete transaction is received, is termed a controlling connection or a coordinating connection.

In an alternative approach where the database client creates subtransactions, the subtransactions can be sent to the database server by the database client on multiple connections (as shown on FIG. 2B). As with the previous example, internally, the database server associates a process/thread with each connection to execute them in parallel. In this example, each created subtransaction can be associated with a single connection. One subtransaction is designated as a controlling subtransaction and is submitted to the database server on a controlling connection. This controlling connection is used to instruct database to begin and then commit/rollback the entire transaction group of which the controlling subtransaction is a part.

In FIG. 2B, database architecture 201 has database client 295 and database 210. Database 210 has connections 245A-B, controlling connection 247, database engine 240 and database store 250. Connections 245A-B and controlling connection 247 are coupled to database engine 240. Member subtransaction 215A is relayed using controlling connection 247 and member subtransaction 215B is relayed using connection 245B. Database engine 240 is further coupled to database store 250.

As noted above, in a database client connected to database 210, conventional transaction 112 can be processed and divided into independent member subtransactions 215A-B before the transaction is sent to transaction receiver 260 on database 210.

In database 210, one approach used to promote parallelism in transaction processing enables client 295 to use separate connections to request processing of respective member subtransactions 215A-B. In one approach, after a transaction is divided into member subtransactions on client 295, each member subtransaction 215A-B is assigned to a different connection. Once member transaction 215A is started on controlling connection 247, statements 115A-B are processed by database engine 240 using the connection. Statements 115A-B issued on controlling connection 247 are executed as part of member subtransaction 215A as if being executed in a conventional transaction.

As noted above, member subtransaction 215A uses controlling connection 247. In an embodiment, the member transaction that is executed using the controlling channel can be termed the controlling subtransaction. For example, because member transaction 215A is executed on controlling connection 247, member subtransaction 215A is the controlling transaction of transaction group 212. A controlling transaction in a transaction group is used to manage the operation of other member subtransactions in the transaction group. Different transaction group operations managed using the controlling transaction include committing the member subtransactions and rolling back member subtransactions. Committing and rolling back of transaction groups are discussed with the description of FIG. 3 below.

Once member subtransactions 215A-B are started on respective connections, respective statements 115A-B and 115C in member subtransactions are executed on the connections. Statements 115A-C issued on respective connections are executed as part of the member subtransactions 215A-B. For example, transactional locks acquired while executing statements are owned by the member transaction and are not released until this member transaction commits or rolls back. The coordination of committing and rolling back member subtransactions 215A-B is discussed with the description of FIG. 3 below.

### Transaction Group Processing

FIG. 3 is a block diagram of a database having a commit/rollback engine. Database 310 has commit/rollback engine 380, database engine 340, database store 350 and database log 352. Database engine 340 is coupled to database store 350. Database log 352 has status information 353. Database language items 370 include transaction group 312 having controlling member subtransaction 315A and member subtransactions 315B-C. Controlling member subtransaction 315A contains statements 316A-B, and member subtransactions 315B-C contain statements 316C-D respectively. Database 310 is operated on computer server 390.

Embodiments use different approaches to handling the commit/rollback request, failure, and recovery processes for transaction members 315A-C in transaction group 312.

As discussed with the description of FIGS. 2A-B above, database 310 enables member subtransactions 315A-C to be executed using multiple processses/threads. Embodiments process member subtransactions 315A-B in an approach that ensures atomic commit operations for each member subtransaction 315A-C and the entire transaction group 312.

Transaction Group Commit/Rollback

One characteristic of member subtransactions 315A-C and transaction group 312 is that, for a given transaction group, every member subtransaction must successfully complete included statements before the transaction group can commit.

Transaction Group Rollback

An embodiment provides a mechanism for rolling back all subtransactions in a transaction group. For example, if statement 316B of member subtransaction 315A is unable to successfully complete, then all statements of member subtransactions 315A-C of transaction group 312 must be rolled back. This transaction group rollback process can also be termed “group-abort processing.”

To improve performance, in some embodiments, certain trigger events can immediately cause a group-abort for a transaction group. The access, or attempted access, by a statement in a member subtransaction of restricted data is one trigger event that can cause transaction group-abort processing.

As discussed with the description of FIG. 2A above, for some embodiments, it is required that operations in different member subtransactions of a transaction group not operate on common data. Listed with the description of FIG. 2A above, examples E1-E2 give examples of circumstances where statements are operating on common data and thus cannot be allocated into different member subtransactions.

During the execution of member subtransactions, the same examples E1-E2 illustrate different circumstances where common data is modified by different member subtransactions. In an embodiment, when a member subtransaction violates restrictions upon access to common data, the entire transaction group is rolled back by commit/rollback engine 380.

This section describes the mechanism used to rollback the entire transaction group when the process executing one of the member subtransactions or the coordinating transaction runs into fatal errors.

In one approach to rolling back transaction group 312, when a member transaction fails, the faulty member transaction will rollback itself and send an indication to the controlling transaction of the transaction group. The controlling transaction then coordinates the rollback of the remaining member subtransactions of the transaction group. In one approach to achieve this, the controlling subtransaction signals all the member subtransactions to rollback associated work. During the execution flow of a member subtransaction, when a subtransaction receives this rollback signal, associated work is rolled back.

In an example, controlling member subtransaction 315A is executed by controlling connection (e.g., controlling connection 247 from FIG. 2B) and member subtransaction 315B is executed by a non-controlling connection (e.g., connection 245B). When statement 316C of member subtransaction 315B fails, commit/rollback engine 380 rolls back member subtransaction 315B. Commit/rollback engine 380 also notifies controlling member subtransaction 315A. Controlling member subtransaction 315A then coordinates the rollback of remaining member subtransaction 315C.

Recovery of Transaction Group

In an embodiment, when server 390 fails while transaction group 312 is running in database 310, the recovery following the server 390 failure assures that either all or none of member subtransactions 315A-C of transaction group 312 commit. One approach to transaction group 312 recovery uses controlling member subtransaction 315A and database log 352

As noted above, controlling member subtransaction 315A manages the operation of member subtransactions 315B-C in transaction group 312. In an example, as transaction group 312 operates, each member subtransaction stores the identity of its controlling subtransaction in the database log. In this way, different recovery mechanisms are directed toward the controlling subtransaction for each the member subtransaction. The end-status commit/rollback noted in the database log for the controlling subtransaction acts as reference point for recovery to determine to commit/rollback a member transaction. A member transaction will be committed by recovery only if its controlling transaction end state is commit, otherwise, the recovery will rollback the member subtransaction. In an embodiment, the final state of a controlling transaction (as determined from the database log) can be used as a reference to perform the recovery of all unfinished subtransactions. This ensures that at recovery time all the member transactions will reach the same end state (either commit or rollback).

After a failure of server 390 during the execution of transaction group 312, commit/rollback engine 380 uses status information 353 to determine the status of member subtransactions 315A-C. When all of member subtransactions 315A-C are unable to commit, commit/rollback engine 380 performs the rolling back of other member subtransactions 315B-C.

### Committing a Transaction Group

After an embodiment has finished executing all the member subtransactions of a transaction group, the transaction group can be committed. Committing a transaction group means committing all of the member subtransactions of the transaction group.

In one approach, an embodiment issues the commit command to commit transaction group 212 on controlling connection 247. Commit of transaction group 212 will be allowed to succeed only if all the member subtransactions 215A-B have successfully finished their SQL statements. If commit processing for one of the member subtransactions or the controlling transaction fails, then transaction group 212 will be rolled back using an approach described above.

In model where database client 295 creates and issues subtransactions, when client 295 completes all the statements in a member subtransaction, it indicates to database 210 that the member subtransaction has completed. If all the member subtransactions have not finished their SQL statements then the command to commit the transaction group (on controlling connection 247) waits for all the member transaction to be completed. Once all the member subtransactions are completed, the commit processing for the transaction group begins.

In an embodiment, to ensure that all the member subtransactions reach same final state (commit or abort), a two phase commit mechanism is used to commit a transaction group. The process initiating the two-phase commit mechanism will first prepare all the member subtransactions (215A-B) of transaction group 212 for committing. Once member subtransactions 215A-B are prepared, an embodiment will first commit the coordinating transaction of the specified transaction group and then commit the member subtransactions one after the other.

Two phase commit/rollback processing across the controlling transaction and associated subtransactions can insure the atomicity across different member subtransactions in event of failures during commit processing. Commit of transaction group 212 will succeed only if all the member transaction 215A-B can commit successfully. If commit processing for one of member subtransactions fails or the coordinating transaction fails then the transaction group will be rolled back by an embodiment.

This two-phase approach can also be used with the rollback mechanisms described above. In a two-phase rollback, an embodiment will first rollback the coordinating transaction of the specified transaction group and then rollback the member subtransactions one after the other.

### Deadlock Detection

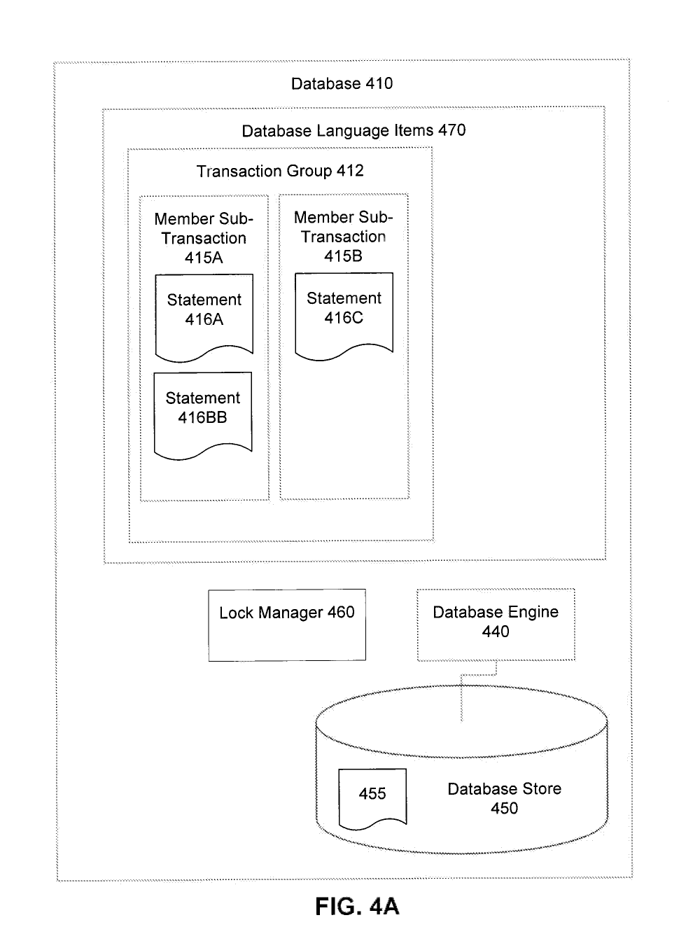

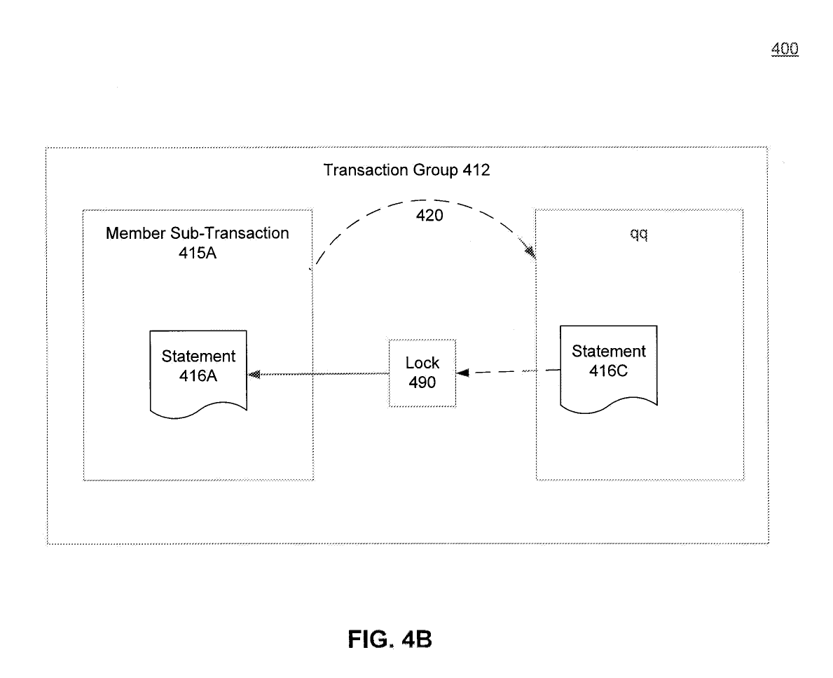

FIG. 4A is a block diagram of a database having a lock manager. Database 410 has lock manager 460, database language items 470, database engine 440 and database store 450. Database language items 470 includes member subtransactions 415A-B, having statements 416A-B and 416C respectively. Database store 450 has a data item 455. In an example, data item 455 can be a database table. As discussed below with the description of FIG. 4B, lock manager 460 can manage locks used by statements 115A-C.

FIG. 4B is another view of transaction group 412, having member subtransactions 415A-B. Member subtransactions 415A-B include statements 416A and 416C respectively. Lock 490 is a lock on a data item 455, and is held by statement 416A. Statement 416C also requires access to data item 455, and makes a request for lock 490. Dependency 420 shows member subtransaction 415A as depending for completion upon the committing of subtransaction 415B. This dependency comes from the fact that 415A cannot release the lock 490 until it commits and which cannot happen until 416C completes its SQL statements.

As would be appreciated by one having skill in the relevant art(s), given the description herein, block diagram 400 depicts a deadlock condition between member subtransaction 415A and member subtransaction 415B as the subtransactions cannot proceed from this point. As depicted, when subtransaction 415A both holds lock 490 and depends upon the completion of member transaction 415B (by statement 416C), such transaction 415B depending on lock 490 to get released by subtransaction 415A, a deadlock can result.

As discussed above with the description of FIG. 2A, member subtransactions 415A-B in transaction group 412 should not access the same data-item. As discussed above with the description of FIG. 2A, statements can be allocated to member subtransactions based on different criteria. Ideally, during this phase, a determined likelihood that the same data-item would need to be accessed by statements 416A and 416C would cause the statements to be initially allocated to the same member subtransaction by independence determiner 270. The dependency depicted on FIG. 4B could however have been unpredictable during the analysis performed by independence determiner 270, such dependency only resulting at run-time. In an embodiment, when deadlock scenarios occur, they are detected and corrective action is taken to resolve the deadlock.

To track the execution of transaction group 412, an embodiment assigns a unique “family identifier” (also termed “family ID”) to each member subtransaction 415A-B in transaction group 412. Each statement 416A-C can be linked by a family ID because of their allocation to a particular member subtransaction.

In an embodiment, the family ID of each member transaction 415A-B is used to help detect the type of deadlock shown in FIG. 4B. Because both statements 416A and 416C belong to a same transaction group 412, they share the same family ID. When statement 416C makes a request for lock 490, lock manger 460 uses the family ID of both statements to determine that this request is conflicting with lock 490 as held by statement 416A. Once database server detects the deadlock using the family id, it rolls back the transaction group using the “group abort” processing mentioned above.

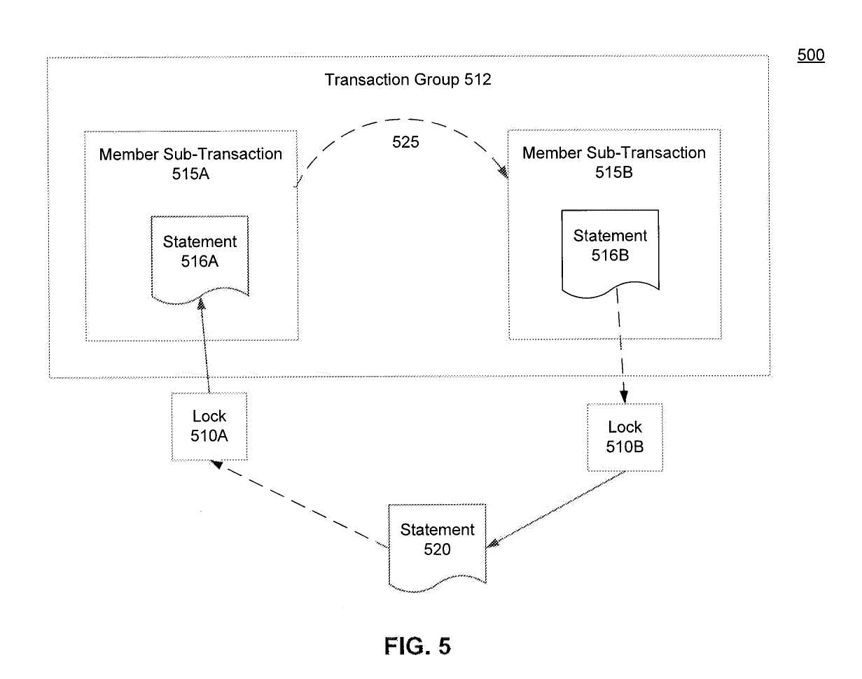

FIG. 5 is a block diagram 500 of transaction group 512, having Member subtransactions 515A-B. Member subtransactions 515A-B include statements 516A-B respectively. A statement 520 is shown that is not a part of transaction group 512. Lock 510B is a lock on data item 455 and is held by statement 520. To complete, statement 520 requires a lock 510A on another data item in database store 450 (not shown). Lock 510A is held by statement 516A of member subtransaction 515A. Statement 516B requires lock 510B on data item 455 for completion. Dependency 525 is shown to reflect the dependency of member subtransaction 515A upon the committing of member subtransaction 515B.

As noted above with the description of FIG. 2A, because of the structure of transaction groups, member subtransaction 515A has a dependency 525 for final completion (commit) upon member subtransaction 515B. In an embodiment, the dependence between member subtransactions causes an implicit dependency between statement 516A and 516B.

As would be appreciated by one having skill in the relevant art(s), given the description herein, block diagram 500 depicts a deadlock between member subtransactions 515A-B in transaction group 512, and a statement 520 outside transaction group 512.

In an embodiment, if a member subtransaction is selected as the cause of the deadlock then it will lead to rollback of entire transaction group. If a non-member statement is selected as the cause of the deadlock, then it will be rolled back and the member subtransactions of the transaction group can continue their processing. For example, if statement 516A is selected as the cause of a deadlock, then member subtransactions 515A-B will be rolled back, and statement 520 will continue execution. Similarly, if statement 520 is selected as the cause of the deadlock, then this statement will be rolled back, and member subtransactions 515A-B of transaction group 512 will continue execution.

### Method 600

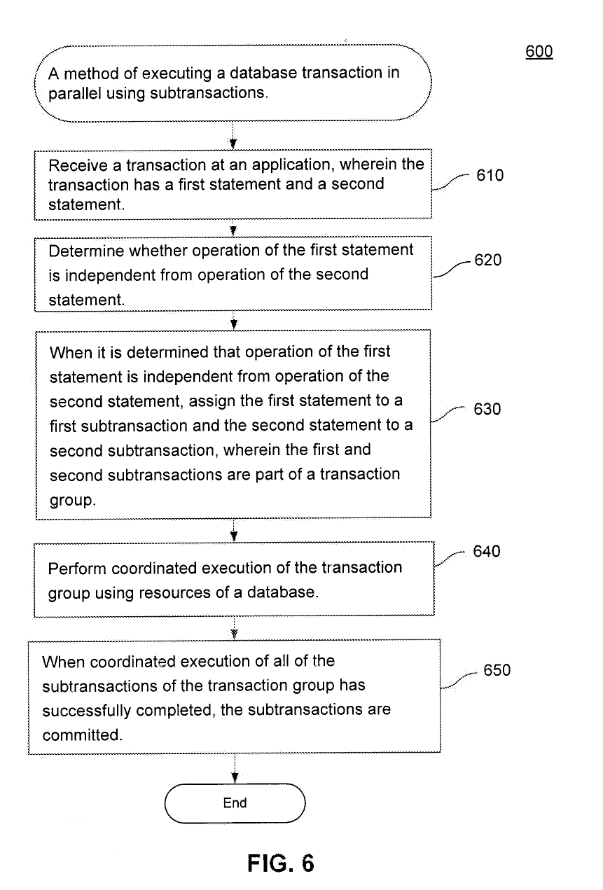

This section and FIG. 6 summarize one of the techniques described herein by presenting a flowchart of an exemplary method 600 of executing a database transaction in parallel using subtransactions. While method 600 is described with respect to an embodiment of the present invention, method 600 is not meant to be limiting and may be used in other applications.

As shown in FIG. 6, an embodiment of method 600 begins at stage 610 where a transaction is received at an application, the transaction having a first statement and a second statement. In an embodiment, as shown on FIG. 1, a transaction, for example transaction 112, is received at an application, for example database 210, the transaction having two statements, for example, statements 115A and 115C. In another example, client 295 is an application where a transaction is received. Once stage 610 is complete, method 600 proceeds to stage 620.

At stage 620, a determination is made whether operation of the first statement is independent from operation of the second statement. In an embodiment, as shown on FIG. 2A, the operation of two statements, for example statements 115A-B, is analyzed, for example by independence determiner 270. Once stage 620 is complete, method 600 proceeds to stage 630.

At stage 630, when it is determined that operation of the first statement is independent from operation of the second statement, the first statement is assigned to a first subtransaction and the second statement is assigned to a second subtransaction, the first and second subtransactions being part of a transaction group. In an embodiment, when it is determined that operation of the first statement is independent from operation of the second statement, for example statements 115A and 115C, the first statement, for example statement 115A, is assigned to a first subtransaction, for example member subtransaction 215A, and the second statement, for example statement 115C, is assigned to a second subtransaction, for example member subtransaction 215B, the first and second subtransactions being part of a transaction group, for example, transaction group 212. Once stage 630 is complete, method 600 proceeds to stage 640.

At stage 640, the transaction group is executed in a coordinated manner using resources of a database. In an embodiment, the transaction group, for example transaction group 212, is executed in a coordinated manner using resources, for example, database engine 240, of the database, for example database 210. Once stage 640 is complete, method 600 proceeds to stage 650.

At stage 650, when coordinated execution of all of the subtransactions of the transaction group have successfully completed, the subtransactions are committed. In an embodiment, when execution of all of the subtransactions of the transaction group, for example, member subtransactions 215A-B in transaction group 212 executed by database engine 240, have successfully completed, all of the subtransactions, for example, member subtransactions 215A-B, are committed, for example, committed to database store 250 by database engine 240. When stage 650 is completed, method 600 ends.

### Example Computer Embodiment

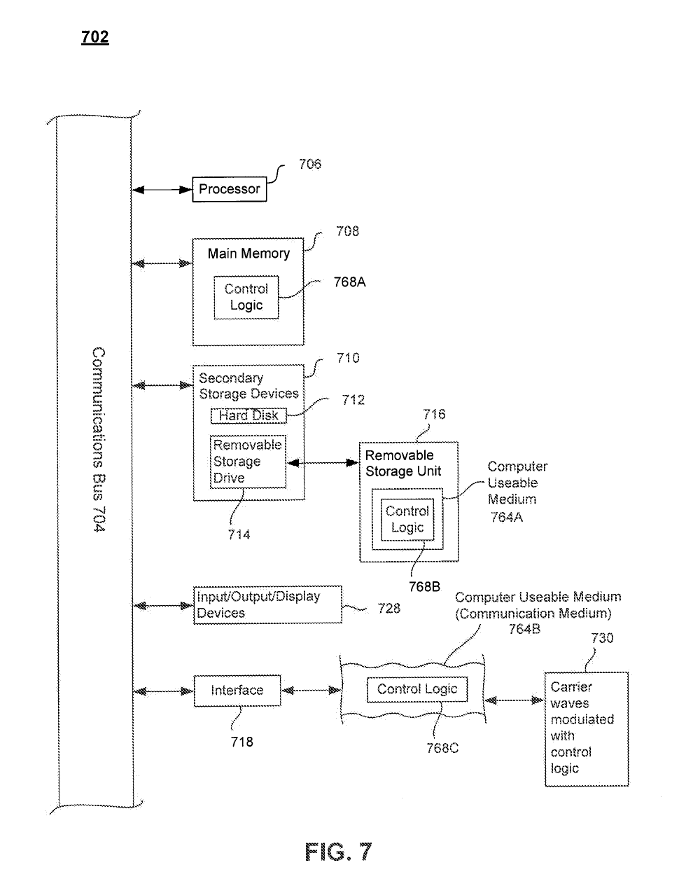

In FIG. 7, the system and components of embodiments described herein are implemented using well-known computers. For example, all of the components in FIGS. 2-5, the database system architectures shown in FIGS. 2A-4A, and the operation of the flowchart in FIG. 6 described above, can be implemented using computer(s) 702.

Computer 702 can be any commercially available and well known computer capable of performing the functions described herein, such as computers available from International Business Machines, Apple, Sun, HP, Dell, Compaq, Digital, Cray, etc.

The computer 702 includes one or more processors (also called central processing units, or CPUs), such as a processor 706. The processor 706 is connected to a communication bus 704. The computer 702 also includes a main or main memory 708, such as random access memory (RAM). The main memory 708 has stored therein control logic 768A (computer software), and data.

The computer 702 also includes one or more secondary storage devices 710. The secondary storage devices 710 include, for example, a hard disk drive 712 and/or a removable storage device or drive 714, as well as other types of storage devices, such as memory cards and memory sticks. The removable storage drive 714 represents a floppy disk drive, a magnetic tape drive, a compact disk drive, an optical storage device, tape backup, etc.

The removable storage drive 714 interacts with a removable storage unit 716. The removable storage unit 716 includes a computer useable or readable storage medium 724 having stored therein computer software 768B (control logic) and/or data. Removable storage unit 716 represents a floppy disk, magnetic tape, compact disk, DVD, optical storage disk, or any other computer data storage device. The removable storage drive 714 reads from and/or writes to the removable storage unit 716 in a well-known manner.

The computer 702 also includes input/output/display devices 728, such as monitors, keyboards, pointing devices, etc.

The computer 702 further includes a communication or network interface 718. The network interface 718 enables the computer 702 to communicate with remote devices. For example, the network interface 718 allows the computer 702 to communicate over communication networks or communication medium 764B (representing a form of a computer useable or readable medium), such as LANs, WANs, the Internet, etc. The network interface 718 may interface with remote sites or networks via wired or wireless connections.

Control logic 768C may be transmitted to and from the computer 702 via the communication medium 764B. More particularly, the computer 702 may receive and transmit carrier waves (electromagnetic signals) modulated with control logic 730 via the communication medium 764B.

Any apparatus or manufacture comprising a computer useable or readable medium 764 having control logic (software) 768B stored therein is referred to herein as a computer program product or program storage device (which are articles of manufacture). This includes, but is not limited to, the computer 702, the main memory 708, secondary storage devices 710, the removable storage unit 716 and the carrier waves modulated with control logic 730. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### Conclusion

Embodiments described herein provide methods and systems for executing a database transaction in parallel using subtransactions. The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. A method of executing a database transaction in parallel using subtransactions, comprising:
receiving a transaction at an application, wherein the transaction has a first statement and a second statement:
determining whether operation of the first statement is independent from operation of the second statement;
when it is determined that operation of the first statement is independent from operation of the second statement, assigning the first statement to a first subtransaction and the second statement to a second subtransaction, wherein the first and second subtransactions are part of a transaction group;
performing coordinated execution of the transaction group using resources of a database; and
when coordinated execution of all of the subtransactions of the transaction group has successfully completed, the subtransactions are committed.

2. The method of claim 1, wherein receiving a transaction at an application comprises receiving a transaction at a database client coupled to the database.

3. The method of claim 1, wherein receiving a transaction at an application comprises receiving a transaction at a database from a database client.

4. The method of claim 1, wherein determining based on the defining statement comprises determining based on a structured query language (SQL) statement, and receiving a transaction having a first statement and a second statement comprises receiving a transaction having a first SQL statement and a second SQL statement.

5. The method of claim 1, wherein executing the subtransactions using resources of the database comprises protecting the execution of the subtransactions from being deadlocked during execution using resources of the database.

6. The method of claim 1, further comprising, when the first subtransaction in the transaction group satisfies a first condition, rolling back all subtransactions in the transaction group.

7. The method of claim 6, wherein the first subtransaction satisfying the first condition comprises the first subtransaction failing to execute.

8. The method of claim 6, wherein the first subtransaction satisfying the first condition comprises the first subtransaction issuing a request for a lock that is held by the second subtransaction.

9. The method of claim 6, wherein rolling back all subtransactions in the transaction group comprises rolling back all subtransactions in the transaction group based on a database log of the database.

10. The method of claim 1, wherein assigning the first statement to a first subtransaction and the second statement to a second subtransaction comprises assigning the first statement to a controlling subtransaction and the second statement to a member subtransaction.

11. The method of claim 10, wherein upon a recovery event, the controlling subtransaction is successfully committed or rolled back before a process to commit or rollback the member subtransaction is commenced.

12. The method of claim 10, wherein upon a recovery event where the member transaction is unfinished, the member transaction is recovered based on a final state of the controlling subtransaction.

13. The method of claim 12, wherein, the member transaction is recovered based on a final state of the controlling subtransaction comprises recovering the member transaction based on the final state of the controlling transaction as indicated by a database log.

14. An application configured to parallel execute a database transaction using subtransactions, comprising:
a transaction receiver configured to receive a database transaction having a first statement and a second statement;
an independence determiner configured to determine whether operation of the first statement is independent from operation of the second statement;
a subtransaction creator configured to, when it is determined that operation of the first statement is independent from operation of the second statement, assign the first statement to a first subtransaction and the second statement to a second subtransaction, wherein the first and second subtransactions are part of a transaction group; and
a database engine configured to:
parallel execute the subtransactions, and
when execution of all of the subtransactions have successfully completed, commit all of the subtransactions.

15. The application of claim 14, wherein the independence determiner is configured to determine that operation of the first statement is independent from operation of the second statement based on a defining statement that is a structured query language (SQL) statement, and wherein the transaction receiver is further configured to receive a database transaction having a first SQL statement and a second SQL statement.

16. The application of claim 15, wherein the database engine is further configured to protect the execution of the subtransactions from being deadlocked during execution.

17. The application of claim 14, wherein the database engine is further configured to, when the first subtransaction in the transaction group satisfies a first condition, roll back all subtransactions in the transaction group.

18. The application of claim 17, wherein the first condition comprises the first subtransaction failing to execute.

19. The of claim 17, wherein the first condition comprises the first subtransaction issuing a request for a lock that is held by the second subtransaction.

20. The of claim 17, wherein the first condition comprises the first subtransaction issuing a request for a lock that is held by a statement upon which the second subtransaction depends.

21. The database of claim 17, wherein the database engine is further configured to roll back a subtransaction in the transaction group based a database log of the database.

22. A computer-readable medium having computer-executable instructions stored thereon that, when executed by a computing device, cause the computing device to perform a method of executing a database transaction in parallel using subtransactions, the instructions comprising:
receiving a transaction at an application, wherein the transaction has a first statement and a second statement;
determining whether operation of the first statement is independent from operation of the second statement;
when it is determined that operation of the first statement is independent from operation of the second statement, assigning the first statement to a first subtransaction and the second statement to a second subtransaction, wherein the first and second subtransactions are part of a transaction group;
performing coordinated execution of the transaction group using resources of a database; and
when coordinated execution of all of the subtransactions of the transaction group has successfully completed, the subtransactions are committed.
